(19) United States
(12) Patent Application Publication
(10) Pub. No.: US 2004/0007529 A1
(43) Pub. Date: Jan. 15, 2004

(54) Method for modifying membrane rejection characteristics

(76) Inventors: Leonid Blyankman, Carmiel (IL); Giacomo Mino Negarin, Caesarea (IL)

Correspondence Address: Reed Smith, 29th Floor, 599 Lexington Avenue, New York, NY, 10022, US

(21) Appl. No.: 10/312,971

(22) PCT Filed: Jul. 8, 2001
(86) PCT No.: PCT/IL01/00621

(30) Foreign Application Priority Data
Jul. 9, 2000 (IL) 137226

(51) Int. Cl. B01D 61/00

(52) U.S. Cl. 210/652

(57) ABSTRACT

A method for modifying the rejection characteristics of a reverse osmosis membrane having a separating surface. The method comprises performing oxidation (1) of the reverse osmosis membrane, whereby a decrease in the salt rejection of said reverse osmosis membrane takes place, in effect rendering the reverse osmosis membrane ultrafiltration or microfiltration characteristics.

### FIELD OF THE INVENTION

The present invention relates to ultrafiltration or microfiltration membranes. More particularly, the present invention relates to a process for producing an ultrafiltration or microfiltration membrane by modifying a standard reverse osmosis membrane.

### BACKGROUND OF THE INVENTION

Filtration membranes are used as a selective barrier. Membranes allow certain components of a mixture to pass through it while others are retained. The size of the components in the mixture determines the type of separation process to be used, therefore it determines the nature of the membrane and the driving force that controls the process. In order to retain macromolecules or particles larger than about 1-20 nm, ultrafiltration (UF) membranes are used. Separation through UF membranes is a pressure driven process in which hydraulic pressure may be applied in order to speed up the process (transmembrane pressures are typically between 15 to 100 psi).

Membranes in general are characterized by their pore size that determines the membrane performance. The pore size of UF membranes ranges between 2 to 100 nm. In UF membranes it is customary to characterize a “molecular weight cut off” (MWCO—molar mass limit) in order to define the size of particles that the membrane retains. It should be mentioned that for solutes of unusual shape such as expanded coils or rods (especially in proteins), one should consider the size and shape rather than the molar mass cutoff.

Membranes that are used for UF are commonly made of polymeric materials but recently, membranes that are inorganic in nature are also produced. Materials that are used for the manufacturing of UF membranes are reported in “ULTRAFILTRATION AND MICROFILTRATION HANDBOOK” published by Technomic Publishing Company, Inc. in 1998 edition p. 42 and are cellulose (regenerated), ceramic composites (zirconia on alumina), polyacrylonitrile (PAN), polyvinyl alcohol (PVA), polysulfone (PS), polyethersulfone (PES), cellulose acetate (CA), cellulose triacetate (CTA), polyamide, aromatic (PA) and polyimide (PI).

UF membranes are known in the art since the 1960's and are usually made from a porous support that acts as a mechanical support onto which a permselective layer is built. The resistance to mass transfer is solely determined by the permselective layer. Permselective layers may be employed on one or both surfaces of the membrane, even though the asymmetric structure is preferable. The asymmetric structure is used for manufacturing UF membranes as well as other membranes such as reverse osmosis (RO) membranes, microfiltration membranes and nanofiltration membranes.

Attempts are made to make better membranes by tailoring other polymers. For example, a polypropylene membrane is usually used for microfiltration but it is desired to employ this material for other purposes. A hydrophilic polyethylene membrane is disclosed in U.S. Pat. No. 5,976,434 “METHOD FOR PREPARING HYDROPHILIC POLYETHYLENE MEMBRANE” filed in 1998 by Chung T-C. This patent discloses polypropylene (PP) membranes having a hydrophilic surface that is prepared by extracting a fugitive hydrophilic pore-forming agent from a gelled film prepared by evaporating the solvent from a homogeneous solution of isotactic polypropylene, functionalized polypropylene and the fugitive agent in a solvent, such as xylene. Most of the functional groups in the functionalized polypropylene are located on the surface of the membrane, including pore surface. The resulting membranes, especially membranes having an asymmetric structure, are useful for ultrafiltration, dialysis and/or microfiltration.

Surface modification is used to adjust the pore size so as to suit the desired applications of a membrane. An example of such modification is disclosed in U.S. Pat. No. 4,690,766 “CHEMICALLY MODIFIED SEMIPERMEABLE POLYSULFONE MEMBRANES AND THEIR USE IN REVERSE OSMOSIS AND ULTRAFILTRATION” filed in 1985 by Linder C. et al. the disclosed membranes are in general composed of a thin crossed linked hydrophilic film, chemically bonded to a thicker, more porous, crosslinked membrane. The membranes are polysulfones modified by a sequence of different chemical reaction steps while the final membrane is useful in ultrafiltration and reverse osmosis and especially for applications in the range of pressures (5-50 bar) and cut offs (200 to 2000 MW) associated with membranes between RO and UF.

Another surface modification process is disclosed in U.S. Pat. No. 5,846,428 “METHOD FOR MODIFYING THE SURFACE OF A POLYMER MEMBRANE, AND A MEMBRANE THUS MODIFIED”, filed in 1996 by D. Martin. This patent concerns a method for modifying the transfer characteristic of a porous organic or inorganic membrane by applying homogeneous solution obtained by mixing one or more rare-earth or alkaline-earth flouroalkoxides in an anhydrous organic solvent. The membranes thus modified are useful for the regeneration of photographic solutions or for the separation of organic compounds from aqueous effluents. Another surface modifying process is disclosed in U.S. Pat. No. 5,928,792 “PROCESS FOR MAKING SURFACE MODIFIED POROUS MEMBRANE WITH PERFLUOROCARBON COPOLYMER” filed by W. Moya in 1997. This patent discloses a process provided for producing a porous membrane product comprising a porous membrane substrate that is contacted with a solution containing a perfluorocarbon copolymer composition to bind the composition onto the substrate surface.

Improvements of existing membranes in order to change the pore size and shape so that they may be used for separating smaller molecules are also in progress. An example is disclosed in U.S. Pat. No. 5,942,120 “COMPOSITE MICROPOROUS ULTRAFILTRATION MEMBRANE, METHOD FOR MAKING THEREOF, AND SEPARATION METHOD” filed in 1997 by K. Wilkinson. This patent involves a microporous ultrafiltration membrane containing polymeric material having oxyalkylene tentacles dangling from a carbon backbone that can be improves for separation of micromaterials such as salts, unicellular pathogens and the like.

The processes involved in the manufacturing of ultrafiltration membranes and the improvements of other membranes by surface modifications in order to use them as ultrafiltration membranes make ultrafiltration membranes very expensive. The polymers or other inorganic materials used for manufacturing membranes or modifying the surface of membranes are quite expensive, too, so that ultrafiltration separation becomes an expensive process.

Ultrafiltration is one of the best ways to pretreat a solution before it enters into a reverse osmosis unit. The cost of the UF membranes causes some of the users to eliminate the UF unit, hence to degrade the performance of the RO unit and to decrease its lifetime. The use of RO units in factories is aimed at decreasing the factory costs since it enables reusing treated water in the factory. If the process becomes too expensive due to UF membrane costs, it is not worthy to use UF membranes. The production of drinking water by RO units from polluted sources is one of the applications of RO that is spreading in many countries all over the world, especially in countries where fresh and purified water is scarce. Lowering the costs of installation and/or operation of the units is desirable.

UF membranes are also used in wastewater treatment particularly in chemical factories. Environmentalists all over the world are raising the issue of wastewater treatment and energy savings. It is desirable to reduce the costs of UF membranes so that factories are encouraged to obey the environmental preservation regulations at low costs.

### BRIEF DESCRIPTION OF THE INVENTION

It is an object of the present invention to provide a method for producing an ultrafiltration membrane or microfiltration membrane by modifying standard reverse osmosis membranes.

It is another object of the present invention to provide an ultrafiltration membrane produces by modification of used reverse osmosis membrane so that the resulting ultrafiltration membrane is cheaper than a standard ultrafiltration membrane.

Another object of the present invention is to provide an ultrafiltration membrane produced by modification of used reverse osmosis membrane so that the resulting ultrafiltration membrane withstands higher feed pressures than the standard ultrafiltration membrane.

Yet, another object of the present invention is to provide an ultrafiltration membrane that is stable in harsh conditions such as extreme pH values, oxidants, high concentration of suspended solids, high concentration of oil (edible and mineral) and frequent washing processes with a variety of chemicals.

It is yet another object of the present invention to provide an ultrafiltration membrane that is adapted to be used as stand alone unit that is adapted to act as a bacteria barrier for high hygiene demands.

Another object of the present invention is to provide an ultrafiltration membrane that is adapted to be used for treatment of various kinds of wastewater streams in order to remove suspended solids, organic matter, detergents, oils and so on.

It is yet another object of the present invention to provide an ultrafiltration membrane that is adapted to be used as a reverse osmosis pretreatment unit so that the reverse osmosis unit has lower operational costs, higher reverse osmosis fluxes, longer reverse osmosis membrane lifetime, fewer reverse osmosis membrane washings and less chemicals.

It is thus provided a method for modifying the rejection characteristics of a reverse osmosis membrane having a separating surface comprising performing oxidation of the reverse osmosis membrane, whereby a decrease in the salt rejection of said reverse osmosis membrane takes place, in effect rendering the reverse osmosis membrane ultrafiltration or microfiltration characteristics.

Furthermore, in accordance to another preferred method of the present invention, said oxidation comprises immersing said reverse osmosis membrane in a solution of an oxidizing agent.

Furthermore, in accordance to another preferred method of the present invention, the concentration of said solution of an oxidizing agent is between three and four percent.

Furthermore, in accordance to another preferred method of the present invention, said oxidation is carried out at a temperature between 10 to 30 degrees Celsius.

Furthermore, in accordance to another preferred method of the present invention, said oxidizing agent is an agent chosen from sodium hypochlorite, chlorine derivatives, H₂O₂, potassium permanganate, and ozone.

Furthermore, in accordance to another preferred method of the present invention, further comprising:

a. circulating a hydroxide solution through said reverse osmosis membrane;

b. washing said reverse osmosis membrane with water.

Furthermore, in accordance to another preferred method of the present invention, the hydroxide is chosen from sodium hydroxide, calcium hydroxide and potassium hydroxide.

Furthermore, in accordance to another preferred method of the present invention, the step of circulating a hydroxide solution through said reverse osmosis membrane is carried out at about 45° C., in a pressure vessel.

Furthermore, in accordance to another preferred method of the present invention, said washing is performed in a pressure vessel.

Furthermore, in accordance to another preferred method of the present invention, the pressure in said pressure vessel is in the range of 1 to 6 bars.

Furthermore, in accordance to another preferred method of the present invention, the step of washing said reverse osmosis membrane with water is terminated when the pH of the permeate reaches about seven to eight.

Finally, in accordance to another preferred method of the present invention, the separating surface is made of polyamide.

It is thus provided, membrane obtainable by the method of any one of above mentioned methods.

### BRIEF DESCRIPTION OF THE FIGURES

FIG. 1 illustrates a schematic cross-section of a prior art thin film composite reverse osmosis membrane.

FIG. 2 illustrates a schematic block diagram of modification steps that are performed in order to modify a RO membrane into a UF membrane in accordance to a preferred method of the present invention.

### DETAILED DESCRIPTION OF THE INVENTION

In general, it is the purpose of the present invention to provide a new method by which the surface of a used or new RO membrane is modified and a deliberate yet controlled deterioration in the rejection characteristic of the permselective layer of the membrane occurs. As a result, a membrane that is suitable for UF or MF is produced.

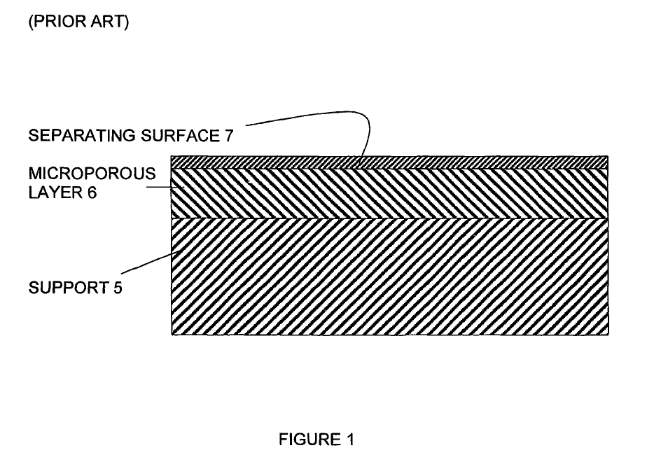

A RO membrane generally comprises two main layers: microporous layer and support layer. The microporous layer has an external separating surface. The RO mambrane to be used in the present invention as the raw membrane can be any membrane that has a permselective layer that is susceptible to oxidation. A commonly used RO membrane that is susceptible to oxidation may be a reverse osmosis composite membrane comprising a porous support membrane layer and a polyamide separation layer such as the RO composite membrane that is disclosed in U.S. Pat. No. 6,026,968. A membrane element of composite RO membrane (namely FILMTEC FT30) that are made from one of the simplest aromatic diamines, 1,3-benzenediamine (metaphenylene diamine) is manufactured by FilmTec Corporation and was used for the experimental section that will be described hereafter. The schematic cross-section of this membrane is shown in FIG. 1. As shown, the polyamide layer is the permselective layer that controls the selectivity of the RO membrane.

The RO raw membrane may be of any desirable configuration. The commonly used membrane configurations for RO membrane elements that may be used for ultrafiltration after modification according to the present invention are plates and frames, porous tubes, hollow fibers, cartridges or spirals. Any other type of membrane configuration to be used as a continuous or batch filtration unit is also covered by the scope of the present invention.

The RO membranes that are used in desalination processes have a certain lifetime after which the water quality or the flow rates are low and the membranes are no longer useful. Since the used RO membranes can not be recovered, they are thrown away after use. Those membranes may be used as the raw membranes for UF membranes manufacturing according to the method of the present invention as long as the membrane elements have a complete structure and were not damaged during their use.

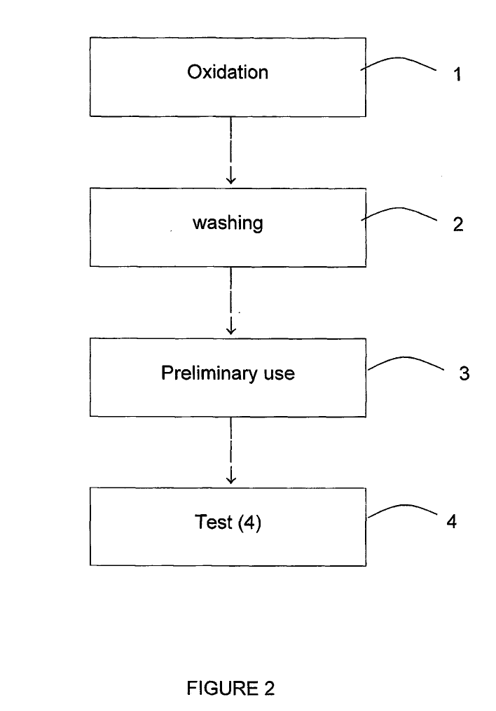

The modification process that a used and complete RO membrane element is going through in order to increase the porosity of the RO membrane and produce an UF membrane is oxidation. Reference is now made to FIG. 2, illustrating a schematic block diagram of optional modification steps that are performed in order to modify a RO membrane into a UF membrane in accordance to a preferred method of the present invention. A step of oxidation (designated by numeral 1) takes place. Oxidation may be performed by an oxidizing agent such as hypochlorite or any other chlorine derivative, H₂O₂, ozone etc. A washing process 2 is performed in order to wash the residues from oxidation 1. A preliminary use 3 is performed by circulating hydroxide. The hydroxide is chosen from the group of materials such as sodium hydroxide, calcium hydroxide or potassium hydroxide. A test 4 is performed in order to evaluate the performance of the resultant membrane. An example of optional modification steps and conditions to be employed on an RO membrane element in order to produce an UF membrane element is as follows:

1. Oxidation process:

1.1 Exposing the RO membrane element to 15-24 hours of oxidation bath in a solution of about 3-4% sodium hypochlorite at 10-30° C.

2. Washing process:

2.1 Placing the membrane element in a pressure vessel.

2.2 Tap water washing in a pressure of about 1 bar at 10-30° C. for about 10 minutes.

2.3 Tap water washing for another 10 minutes with feed pressure of about 6 bars and permeate pressure of about 4 bars. The recovery ratio is between 10-20%.

3. Preliminary use wash:

3.1 recirculating 0.5-1% sodium hydroxide solution at about 45° C. while the feed pressure is about 6 bars and the permeate pressure is about 4 bars. The RO membrane element recovery ratio is 10-20%.

3.2 Washing the membrane element with tap water for about 10 minutes at 10-30° C. in pressure conditions of 6 bars in the feed pressure and 4 bars in the permeate pressure. The recovery ratio is 10-20%. An indication for the termination of this step is that the permeate reached a pH value of 7-8.

4. Membrane element test:

4.1 Tap water recovery at 20° C. while feed pressure is about 6 bars and permeate pressure is about 4 bars. The recovery ratio is about 15%.

4.2 Test results in which the permeate conductivity is similar to the feed conductivity and the permeate flux is between 25-70 liters/hr m² indicate that the modification was successful.

FILMTEC FT30 from Filmtec Corporation RO membrane elements that were exposed to modification process as indicated in the exemplary modification steps were examined and compared to a polysulfone UF membrane (a SPIRA-CEL spiral module manufactured by CELGARD). The modified membrane was tested and was found to accord the performance of a UF membrane element while showing excellent durability. The modified membrane was used in tap water RO pretreatment for about three years and show stable reduction in silt density index (SDI) levels from 5 to 1. There was no reduction in performance of the modified membrane for the whole period of time.

The modified membrane element was used also for wastewater treatment in a detergent company for four years while reducing the anionic detergent active matter from 40,000 ppm to about 2000 ppm. The total solid levels were lowered by the modified membrane element from 90,000 ppm to about 4,000 ppm.

In a test that was carried out in wastewater treatment, two UF membranes were compared. The following test results were obtained:

| | Polysulfone membrane | | Modified membrane | |
|---|---|---|---|---|
| Test factors | Feed | Permeate | Feed | Permeate |
| Turbidity [NTU] | 560 | 29 | 1000 | 20 |
| Color [Pt/Co scale] | 2280 | 97 | 2750 | 95 |
| TSS [ppm] | 510 | 20 | 600 | 20 |
| COD [ppm] | 17600 | 3030 | 13500 | 3000 |
| Anionicsurfactant [%] | 0.2 | 0.02 | 0.25 | 0.015 |

The polysulfone membrane exhibited fluxes of about 8.1 liters/hr m² while the fluxes through the modified membranes of the present invention were about 25-30 liters/hr m². The flux of the polysulfone membrane decreased after two hours of operation and was not recovered by washing processes while the modified membranes of the present invention showed stable fluxes of 25-30 liters/hr m² for more than six months.

As shown by the test results of the modified membrane of the present invention and the comparison of those membranes to a commercial UF membrane, it is obvious that the membranes produced by modifying the RO membrane element according to the method steps of the present invention can be used as UF membranes. The membranes of the present invention can be used for wastewater treatment, for RO pretreatment and for fresh water purification. The modified membranes of the present invention show high performance regarding timelife and fluxes while in comparison with another UF membrane, the modified membrane shows even better permeate quality (lower turbidity, lower COD) in spite of worse feed quality.

The UF membranes produces by the method of the present invention has a molecular weight cut off of about 20 kDalton and have typical rejection rates of about 88-93% in pressure of 3 bars and temperature of about 20° C. (in a stirring cell). The UF membranes withstand a maximal pressure drop of about 4.1 bar. It should be emphasized that microfiltration membranes may be produced by a similar method.

The possibility to benefit from used RO membranes that are bound to be thrown away after use, and in the same time to economize in expensive equipment such as UF membrane elements is very important in the overall economics of a factory. Therefore, producing a high performing UF membrane by deliberate yet controlled deterioration in the porosity of used RO membranes susceptible to oxidation saves the companies many expenses involved in wastewater treatment or in RO pretreatment. The process of manufacturing the UF membranes of the present invention them selves is not expensive and quite simple. The use of any other modification method employed on RO membranes by which a deliberate deterioration in the porosity of the RO membranes occurs is covered by the scope of the present invention.

It should be clear that the description of the methods, the embodiments and attached Figures set forth in this specification serves only for a better understanding of the invention, without limiting its scope as covered by the following claims.

It should also be clear that a person skilled in the art, after reading the present specification could make adjustments or amendments to the attached Figures and above described methods and embodiments that would still be covered by the scope of the present invention.

1. A method for modifying the rejection characteristics of a reverse osmosis membrane having a separating surface comprising performing oxidation of the reverse osmosis membrane, whereby a decrease in the salt rejection of said reverse osmosis membrane takes place, in effect rendering the reverse osmosis membrane ultrafiltration or microfiltration characteristics.

2. A method as claimed in claim 1, wherein said oxidation comprises immersing said reverse osmosis membrane in a solution of an oxidizing agent.

3. A method as claimed in claim 2, wherein the concentration of said solution of an oxidizing agent is between three and four percent.

4. A method as claimed in claim 2, wherein said oxidation is carried out at a temperature between 10 to 30 degrees Celsius.

5. A method as claimed in claim 2, wherein said oxidizing agent is an agent chosen from sodium hypochlorite, chlorine derivatives, H₂O₂, potassium permanganate, and ozone.

6. A method as claimed in claim 1 or 2, further comprising:
c. circulating a hydroxide solution through said reverse osmosis membrane;
d. washing said reverse osmosis membrane with water.

7. A method as claimed in claim 6, wherein the hydroxide is chosen from sodium hydroxide, calcium hydroxide and potassium hydroxide.

8. A method as claimed in claim 6, wherein the step of circulating a hydroxide solution through said reverse osmosis membrane is carried out at about 45° C., in a pressure vessel.

9. A method as claimed in claim 6, wherein said washing is performed in a pressure vessel.

10. A method as claimed in claim 9, wherein the pressure in said pressure vessel is in the range of 1 to 6 bars.

11. A method as claimed in claim 6, wherein the step of washing said reverse osmosis membrane with water is terminated when the pH of the permeate reaches about seven to eight.

12. A method as claimed in claim 1, wherein the separating surface is made of polyamide.

13. Membrane manufactured in the method of any one of claims 1-12.

14. A method for modifying the rejection characteristics of a reverse osmosis membrane substantially as described in the above specification, attached Figures and appending claims.
